(19) United States
(12) Patent Application Publication
(10) Pub. No.: US 2010/0024535 A1
(43) Pub. Date: Feb. 4, 2010

(54) Searching Method for Acquiring Ground Information

(76) Inventors: Yoshito Maeda, Fukuoka (JP); Yoshinori Toyooka, Chiba (JP); Michiaki Sakate, Hiroshima (JP); Katsuo Sakai, Tokyo (JP)

Correspondence Address: JORDAN AND HAMBURG LLP, 122 EAST 42ND STREET, SUITE 4000, NEW YORK, NY, 10168, US

(21) Appl. No.: 12/223,774

(22) PCT Filed: Feb. 7, 2007
(86) PCT No.: PCT/JP2007/052098

§ 371 Date: Oct. 27, 2008

(30) Foreign Application Priority Data
Feb. 8, 2006 (JP) 2006-031360

(51) Int. Cl. G01N 3/00

(52) U.S. Cl. 73/84

(57) ABSTRACT

Provided is a searching method for acquiring ground information by mounting a resistor on the leading end of a rod and by piercing the ground with the same. The searching method acquires the ground information on the strength and deformation of the ground, by piercing the ground with the resistor including a frustum of circular cone or an arcuate member containing a deficient sectional shape, in which the angle made between the side face of the resistor having blades in the same direction as the piercing direction and the piercing direction is 5 degrees or less upward and outward from the leading end of the resistor thereby to measure a plurality of transverse ground reactions, and by rotating the resistor having the blades at that depth thereby to measure a plurality of ground shearing forces. The main information such as CøE can be determined in the ground search by inserting an apparatus of one kind into the search depth without moving it up and down. Thus, an original position ground search can be performed speedily and lightly and applied to various grounds.

### BACKGROUND OF THE INVENTION

1. Technical Field

This invention relates to an in situ test method for acquiring ground information, such as shear strength and modulus of deformation, by piercing a resistor through the ground.

2. Background Technology

Using a resistor penetrating through the ground, the ground is forced to deform by Δ in the horizontal direction, thus generating lateral ground reaction P (see FIG. 1). Under this stress condition, the ground's shear strength can be express as τ=C+Pv tan φ (see FIGS. 2 and 3) and the normal stress Pv (effective stress when ground water is present) is calculated. Cohesive soil mainly consists of cohesion C that is irrelevant to Pv. Sand is defined as a function of internal friction angle φ and strength that is proportional to Pv. Intermediate soil have both C and φ. Moreover, there are cases where residual strength τr generated after failure is required other than maximum shear strength. In addition, the modulus of deformation E is also significant, which is determined using the lateral ground reaction generated when the ground is forced to be deformed by Δ. Therefore, there are three primary ground information factors necessary for design of structures, which are C, φ and E.

The Standard Penetration Test (SPT), illustrated in FIG. 4, is a typical in situ ground test method which is most widely used. In this method, boring is conducted by knocking the head (4) of boring rod (3). The number of blows (N-value) for the resistor (2), attached at the base of hole (1), to penetrate through the ground by 30 cm is counted. Similar to this method is the N vane method which also measures shear strength τ besides N-value and uses a resistor attached with wind vanes around the pipe. The resistor penetrates the ground and forced to rotate in order to measure the shear strength τ under Pv that is near lateral stress condition. A more simple method is the dynamic cone penetration test, which uses a cone instead of pipe as resistor.

FIG. 5 illustrates the electrical static cone penetration test where the cone resistor (6) of point angle 2θ=60 degrees (θ is the angle of penetration) that is set at the tip of rod (7) is allowed to penetrate through the ground statically (without blowing or vibration). The forerunner of this method is the Dutch cone penetrometer test, which classifies ground type using empirical chart. It measures the frictional strength f and pore water pressure Ud besides cone penetration resistance q. Moreover, a similar and very simple method is the portable cone penetration test where the cone of point angle 2θ=30 degrees is forced by the weight of the measurer.

Patented devices related to cone penetration test are supplementary apparatus for reducing penetration resistance of multistage sensors used in the following purposes. In determining the change of ground information (soil pressure, pore water pressure, etc.) according to time using pipes of equal diameter as a reactor that penetrates ground under constant speed. Another uses a load cell that is free to expand and contract in the direction normal to its axis and a multistage type of sensor under high pressure. In the case of displacement control, the multistage type of sensor attached with earth pressure gauge penetrates the tapered soil sample (diameter or width increases in later penetration) under constant speed. In addition, non-patented devices are the step blade and tapered blade. The former is a flat plate equipped with an earth pressure gauge, while the latter is used for estimating earth pressure.

In the Swedish sounding method, as illustrated in FIG. 6, a weight (9) is put over the twisted quadrangular pyramid shaped resistor (8) to determine the relationship of load and subsidence. Also, in the case of ground that does not subside under 100 kgf of load, the resistor is forced to rotate in order to measure the hardness of ground according to subsidence and number of rotations. It is commonly applied in a ground test of detached houses. This method is basically automated and test specifications are not modified as found in related patents.

An in situ vane shear test shown in FIG. 7 is mainly applied in soft cohesive soil ground. The cross-shaped vane (10) is pushed into the ground in the outer tube of double tube rod (11) and is rotated, forcing the ground to shear cylindrically. Thus, direct measurement of strength constant C is possible. The above-mentioned N vane method is the combination of SPT and this vane test. Therefore, currently, the test methods presented in FIGS. 4 to 7 cannot directly measure C, φ and E.

FIG. 8 illustrates the lateral loading test in bore. The pressure cell (12) consists of a rubber tube that is installed in a borehole, and pressurized to expand using an apparatus (13) set on ground. The modulus of deformation E of ground is measured based on the pressure and amount of change in bore diameter. There are two kinds of this method. One is the pre-boring method where the pressure cell is inserted after boring, and the other is the self-boring method where the pressure cell is inserted while boring.

As illustrated in FIG. 9, shear strength τ is measured by applying drawing force to the gauge pipe under pressure where a shear plate is attached on the tip of a pressure cell to prevent slipping. There is a method called pressurization shear test in borehole which determines C, φ and E by performing repeated shear tests of gradually increased pressurization. It can be drawn from the above that the only method which can measure C, φ and E by a single test is the pressurization shear test in the borehole. However, since it requires boring of ground, it is time-consuming and thus, inefficient.

Patent literature 1: JP 1988-297621 Apparatus use for both penetration test and vane test

Patent literature 2: JP 1982-17978 Ground probe method and its apparatus

Patent literature 3: JP 1982-184116 Ground test method and its apparatus

Patent literature 4: JP 1982-184117 Friction reduction apparatus for ground

Patent literature 5: JP 2001-20268 Ground probe apparatus for penetration and rotation of resistor

Patent literature 6: JP 1972-44930 Shearing test apparatus for ground

Patent literature 7: JP 2001-32252 Load test method on borehole and tubular load test apparatus for holding hole

Patent literature 8: JP 1996-285747 Shear test method on borehole for soft bedrock, and its apparatus

Non-patent literature 1: JIS A 1219 Standard penetration test method

Non-patent literature 2: JIS A 1220 Dutch Cone penetrometer method

Non-patent literature 3: JIS A 1221 Swedish sounding test method

Non-patent literature 4: JGS 1411 in situ vane shear test method

Non-patent literature 5: JGS 1421 Lateral load test method on borehole

Non-patent literature 6: JGS 1431 Portable cone penetration test

Non-patent literature 7: JGS 1435 Electrical static cone penetration test

Non-patent literature 8: JH (Former NEXCO) In situ shear friction test SGIFT

It is therefore a first object of the invention to seek a test method that can measure design ground constants C, φ and E in a single test. Presently, the most commonly applied methods are SPT and cone penetration tests which estimate design ground constants such as N and qt, indirectly and relatively. Furthermore, in the cone penetration test shown in FIGS. 10 and 11, the aim is not to find the ground constants but the ground's resistance relative to strength using the penetration resistance of cone (2θ=60 degrees) that can easily penetrate through the soil. Since a large failure region that varies with ground property generates around the cone-shaped resistor, it is proven that cohesion and penetration resistance are not proportional even in cohesive soil. In addition, although τ is measurable from the N vane test, it can not measure C and φ separately. the in situ vane shear test can measure cohesion C in soft cohesive soil but can not measure C and φ separately in other grounds. The modulus of deformation E is measurable using the lateral load test on the borehole. Only the pressurization shear test on the borehole can measure C, φ and E by a single test. There is no simple method for measuring C, φ and E directly in other technical standard's test methods. The reason for this is because the basic specifications of standardized and popularly used for the in situ test are based on old manufacturing and measurement technologies of the past 50 to 70 years. It can be recognized from FIGS. 4 to 7, that even if current technologies are applied for better automation, it is extremely difficult to obtain design constants such as C, φ and E with required accuracy.

A second object of the invention is to improve the test method. Using the same principle, wide applicability to different grounds from soft to moderately hard grounds is desirable. Also, highly accurate results of a detail test and quick interpolation of medial stratum by preliminary test are expected. On the other hand, in the present, test methods of different principle are applied (see FIGS. 4 to 9) due to stiffness of ground and required test precision, the interpretation of ground information results becomes ambiguous.

A third object of the invention is to determine how to measure continuously and rapidly at low cost. Load test in the borehole takes long time in performing one test and it can only measure one to a few meters of depth. FIGS. 4 to 9 show the main specification of the in situ test on the premise that the basic specifications are manual operation and record keeping by visual inspection. There is a problem in the basic specification if an improvement of speed is attempted, precision abruptly deciles when collapse occurs in the borehole during fluctuation of measuring apparatus and rod.

A forth object of the invention is to meet demand for a better penetration resistance reaction apparatus. It should be light weight and have stronger penetration capacity. Problems regarding conventional cone penetration test are listed as follows.

(1) In setting the reaction anchor, it requires extra time and labor besides measuring and test becomes impossible in location where setting is difficult.
(2) It is expensive to carry weights from a few to ten tons. Also, it is not suitable in countries like Japan, for vehicles loaded with heavy weights to transport in narrow and inclined paths in order to conduct several minor tests.
(3) Although the penetration test uses light apparatus and usually efficient in many cases, it produces noise pollution caused by metallic sound while receiving blows.

The above objects will become more apparent in the following explanation with reference to the attached figures herein, wherein the introduction of this invention and its purposes, as well as its new features are compared. It is to be understood that the figures serve wholly for commentary purposes, and do not limit the technical scope of this invention.

### SUMMARY OF THE INVENTION

With regard to the first object on how to measure C, φ and E by conducting one test, a method based on the pressurization shearing test in a borehole is proposed. This method also deals with other problems and provides new ground information that is industrially valuable.

In order to address the second object of the invention which aims for a widely applicable and highly accurate detailed test as well as speedy preliminary test for interpolation, the method should able to penetrate statically in soft grounds, dynamically in relatively hard grounds and by boring (like pre-boring test and trimming test) in harder grounds.

Regarding the third object for making the test method speedy and continuous, specification of cone penetration test is considered as a target. Thus, loading and unloading of measuring device (penetration resistor) must be done, in general, only once in every test spot (in current pressurization shear test in borehole, loading and unloading is not done in every measure depth) and penetration measurement must not be in meter interval but by few centimeter or few decimeters.

Similar to the second object, the forth object directed to making the apparatus light and to having larger penetration capacity can be achieved by combining the dynamic (striking blow) penetration and boring method. Using this approach, uneconomical heavy apparatus and anchorage process can be omitted. In addition, by inserting cushion materials between the knocking head (4) and hammer (5), noise due to percussion can be reduce and rapid loading by impulse force becomes possible. According to the above mentioned basic concepts, details on pressurization shear apparatus for penetration are described below.

A first embodiment of this invention is described in the following. A resistor is mounted on the tip of a rod and it is made to penetrate in order to obtain ground information. The vane of the resistor is rotated in the penetration direction in order to avoid disturbing of ground. Usually, vanes are arranged symmetrical to the axis although in special cases only one vane is required. The height (length) H is about few centimeters or few decimeters long which varies according to total length of resistor and measurement unit. The width B (external width of convex plate transversal to resistor) of vane is set to one to few millimeters. Using the method to be explained later, the normal stress Pv acting on external plane of vane is calculated from the dispersion (reduction) of stress caused by lateral ground reaction P occurred in a remote distance B from the resistor. As to be mentioned later, by increasing B to few centimeters, shearing becomes possible where Pv is small. Using this readily, the values of C and φ can be determined since Pv becomes small by gradually enlarging vane's B where the cylindrical (or belt-shaped θ=0) resistor is made with large diameter by a taper similar to the above mentioned.

By penetrating the inclined resistor, the ground is greatly deformed in the horizontal direction and thus, lateral ground reaction becomes larger. Since the modulus of deformation E of ground is found from the number of combinations of reaction P and deformation Δ, the resistor must have an appropriate angle. Similarly, in order to measure C and φ, the angle of shear failure must be set according to several Pv and failure planes.

The angle θ formed by resistor side surface and penetration axis must be equal to or less than 5 degrees. This angle makes the penetration along resistor side surface while slipping without generating sliding-surface remote from resistor (17 of FIG. 11). It is also the angle of penetration while shearing the ground by increasing the roughness of side surface. Inclination angle is set to θ≦5 degrees based on general conclusion drawn form element tests of triaxial cell used in this invention and researches on included angle of undisturbed samples although the limit inclination angle θr varies with properties of ground and roughness of resistor. Furthermore, even if the resistor satisfies the above conditions, when the length of resistor is increased, the lateral deformation Δ of ground becomes larger, then the ground yields and eventually reach its failure point. Therefore, it is necessary to measure several times within strain level (i.e., ratio of initial radius r0 and Δ is within 1 to 10 percent) of yield pressure.

The following discusses the resistor that has a form of arc or truncated cone with fractured cross-section which is equal to or less than 5 degrees. This is not practical since the tip of cone is fragile due to its extremely acute angle. Also, it bends as it penetrates the inhomogeneous ground because of its pointed tip; this problem is typical to conventional techniques. Therefore, basically, the tip of truncated cone is cut. It penetrates the ground while digging its hollow part (self-boring, SB method) or penetrates through a borehole of relatively small diameter (pre-boring trimming, PBT method). However, based on conventional experiences, this may not be the best method with regards to speed of measurement and as apparatus. Moreover, if the truncated cone-shaped resistor (specially in the case of solid section) penetrates the ground even with small θ, the soil is pushed by the resistor, thus, disturbed soil (about 40% of resistor's radius) thickly sticks around the resistor. As result, the values of E, C and φ correspond to disturbed ground and not to natural round. Considering this fact, as to be mentioned later (FIG. 14 to 26), modification of the resistor is suggested. That is, the greater part of fractured section is cut leaving only the side surface of cone or the belt portion is formed as an arc member. In this way, the ground near the measurement plane will not be disturbed and the soil near the fractured section is removed, making the penetration process easy.

When the resistor mentioned above penetrates the ground, the ground moves by Δ, generating lateral ground reaction P and by rotating the vane of resistor, the ground shears in the form of cone (or arc) at the tip of vane. P and shear strength τ are measured in several spots of different Δ where radius at the tip increases according to θ. Modulus of deformation E can be found from several groups of P and Δ. The normal stress Pv acting on shear plane is calculated using P. C and φ is determined according to its relationship with τ.

An example of a vane shear test according to a first embodiment of the invention includes a load pipe which is attached at the tip of rod which penetrates soft ground statically. If penetration is difficult by this method, a weight is use for administering blows. The resistor is hollow truncated cone and a shoe unit is connected to load pipe with taper of θ≦5 degrees so that the ground would not be disturbed. Also, a dummy vane is attached at the upper part (in order to eliminate the resistance of vane at the bottom). A main part of the resistor is cone-shaped of θ≦3 degrees. This is divided into three equal parts as pressurization shear units, each being attached around the vane of a lateral width in a single line. The most upper part is the upper dummy unit attached with the dummy vane. The pressurization shear unit is divided into two parts. One is an active rotation unit that is connected with a torque transmission key at the load pipe. The other part is a passive rotation unit that is free to rotate and has a connection pin. Tensile force acts on the resistor when load pipe penetrates. Lateral ground reaction P acts on each unit in circular direction of the same center when the three pressurization shear units and dummy unit are dragged underneath. This is measured using 2 load cells as circumferential stress (theoretically both are equal). The normal stress acting on shear plane of vane circumference is calculated using the measured pressure. When the load pipe is rotated, rotational force is transmitted from active rotation unit to passive rotation unit. The resistance of passive rotation unit that is displayed in load cell can be use to compute the shear resistance torque and shear strength. According to this method, E, C and φ in the direction of depth can be calculated by repetition of resistor's penetration and rotation.

The second embodiment of this invention is as follows. A part of resistor side surface or the whole surface is considered as shear plane. The resistor side surface has a roughness that prevents the ground and shear plane from slipping. As a standard, the average roughness of the surface that is the average height from trough to thread of corrugated surface should be greater than half of mean diameter of target soil. The commonly used resistor is formed to have more flat surface by machine work. However, the resistor used herein has rough surface to prevent slipping and in order to measure E as well as shear strength r by penetration. The shear surface has an average roughness that is greater than half of the mean diameter of target soil based on past research results. The boundary surface did not slip and failed by shear slide. In addition, unlike in the first embodiment, shear is continuous in the direction of depth; thus, the speed of test becomes faster since rotation is not necessary. However, C and φ correspond to residual strength τr and not to peak strength. This suggests that this method is useful and economical for interpolation and preliminary tests.

The resistor is cone-shaped and has a fractured section whose angle is equal to or less than 5 degrees, or a resistor with H-shaped section whose angle is equal to or less than 5 degrees is made to penetrate through ground. Since the difference with the first embodiment is not rotational shear, the side surface is not required to be circular (the lateral ground reaction is different for uniform and partial displacement due to Δ). Therefore, the cross section need not necessary be circular for truncated cones and it is possible to use the H-shaped section for the resistor where the ground shears at the flange side. In the case of a hollow and a solid resistor, contents are similar to the first embodiment.

FIGS. 14 to 26, referenced below in greater detail, explain an example of shear test with the rough surface. These figures show resistor portion of pressurization shear apparatus for penetration of resistor with fractured section. FIGS. 14 to 26 correspond to the second embodiment, FIGS. 14, 15, 26, 16, 17 and 18, respectively.

FIG. 14 is the profile diagram of resistor when cut at the center of shear plane lengthwise. The horizontal plane indicated by the arrow is shown in FIG. 18. As for reference, the H-shaped section is shown in FIG. 26. The penetration rod is connected to the head of a resistor rod joint. Penetration force is transmitted to two arc members through diverge joint from this pipe. The pair of arc member end becomes narrow by angle of θ=1 to 2 degrees due to joint member. The shear plane of arc member is uniform from top to bottom but the radius of curvature of exterior becomes smaller at the bottom. However, the tip of a shoe has constant curvature θ=0.

The external portion of a pressurization shear member consists of four units, each having a built-in gauge for measuring a lateral ground reaction P. The force P on both ends of the pressurization shear member that pierce through the hole of joint member each acts at a fix screw). The compressive force generated in a coupling rod for anti-buckling and centering is measured using the gauge for P.

The penetration force of the resistor is transmitted to the shoe and tip of pressurization shear member using two load plates that are connected to the joint member as one. Therefore, since the pressurization shear member is dragged by the shoe during penetration, the shear force of ground is determined by measuring the tensile force at the boundaries of pressurization shear member units. Thus, the internal part of unit boundary is grooved to generate stress concentration and shear force is found from tensile force of each unit using strain gauges. Moreover, the end of pressurization shear member is connected to the shoe. As shown in the figures, the pressurization shear member of T-shape has thin width and flat in both sides in order to measure stress at the center of plate except curvature. A tension gauge is affixed in both sides and a height control plate is set over the plate. A fix pin is fixed by the load plate immediately above the shoe. The tension gauge protected by waterproofed cushion and a cover is fixed with four tapped holes and flattened around the circumference.

The pressurization shear member is built with surface average roughness of 0.5 mm. The end, as shown in FIG. 18, an as described below, is set to have the same thickness with that of pressurization shear member at both sides of load plate. Pressurization shear member is inserted in between and a slide pin is set at the side in order to prevent separation of load plate when sliding vertically. Moreover, in order to eliminate compressive force when rising, the upper part is concealed below the diverged joint (not illustrated). Furthermore, a thin slide sheet is inserted between the pressurization shear member and load plate and it is sealed by an elastic agent in order to protect the connection plane of member from mud.

Cables of various sensors pass through holes near the boundary of joint member and load plate and rise up to rod joint. Then, it passes through penetration rod (not illustrated), pull up to the surface and connect to measurement apparatus (not illustrated). Moreover, FIG. 26 shows conception diagram for H-shaped member and not for arc member.

Next described, is a third embodiment of this invention. Conversion to rapid penetration test is possible by increasing the transmission time of blow energy in the case of penetrating resistor by striking blows. Also, it solves the problem on noise reduction of collision. In addition, ground information is obtain by applying blow energy to piston mass where lubrication fluid is scattered over surface of resistor, thus, friction resistance is reduced and penetration becomes easier. Below explains the examples shown in FIGS. 27 and 28.

Penetration is performed by administering striking blows, where a resistor is attached at the tip of a rod. A hammer is hung (not illustrated) using a rope with a sensor. When the hammer is suddenly dropped, it triggers the initial time of fall and starts various measurement devices within few seconds. When the hammer is lifted up using a connection rope, an automatic knocking head also rises up together. If the lifting is stopped maintaining a constant distance from hammer, the knocking head automatically fixed to rod and the blow force of hammer is transmitted to the rod. Cushion material is put over the knocking block in order to extend the transmission time of blow energy by ten times (in order to apply to various type of ground, time is adjusted by the thickness of cushion material). As result, multiple measurement of information from various sensors becomes possible and suggest solution to noise reduction.

A mechanism example on how to make penetration easy by decreasing the friction of resistor surface (other than shear plane) is next described. Inside the resistor or a rod case, are a cylinder and support for expansion and contraction which are filled with lubricant fluid. A piston that is also used as weight comprises a pipe fixed at the top as support, a spring for holding, a dashboard with holes attached to the cylinder and a spring inserted in between. The piston touches the base of dashboard on top of cylinder. The blow force is transmitted through the rod to the dashboard with holes. The piston becomes the downward force as product of its mass and acceleration. The spring is compressed and lubricant fluid is spitted out of a fluid ejection tunnel; a valve is installed (not illustrated) to prevent subsurface water from flowing backward to the end). In this case, the fluid inside the support for expansion and contraction at the top of piston passes through the dashboard with holes and flow inside the cylinder. Then, while the piston gradually rises due to spring force, it passes through the tunnel installed inside the piston and flow to the cylinder below the piston from the valve. Moreover, easy expansion and contraction of support becomes possible since the internal of rod is connected to the surface and pressure is set below atmospheric pressure (below hydraulic pressure during water flow). Also, dry coating or self-printing materials are applied to the surface in order to improve the reduction of friction on resistor.

### EFFECT OF INVENTION

As explained clearly from the above, the following effects can be obtained in this invention. (1) Measurement of ground information required for design such as cohesion C, internal friction angle φ and modulus of deformation E from single test by penetration (and rotation) through resistor becomes possible. In conventional method, test procedure is complicated even using exclusive test devices, C, φ and E are measured separately. In most typical method, values are estimated using correlation of alternative information (index information).

(2) C, φ and E is measurable by single test that is extremely fast and uses apparatus that can be used by any person. The test apparatus such as the resistor can be use once for every test spot, compared to conventional and common method where the apparatus has to be lift up to the surface and then bring down every time measurement is performed, thus, test speed of this invention is significantly improved.

(3) This invention resistor can obtain the ground information according to necessity by penetration as to be discuss later. It combines the penetration shear test which provides outline values at top speed and the pressurization rotation shear test which gives detailed measurements by penetration and rotation. In the case of thick homogeneous ground layer, the later is use within typical depth and the former is use in most part of ground. This invention has different test procedure compared to conventional preliminary and detail test methods. Also, there is a big difference in precision.

(4) This invention is applicable to various type of grounds. Static penetration is applied in weak ground, penetration by administration of blows is used in moderately hard ground and pre-boring trimming method is employ in extremely hard ground. In comparison to conventional methods, different tests are used with different types and stiffness of ground.

(5) Using the apparatus mentioned above in different penetration methods, anchorage setting, heavy machineries for counterweight and heavy oversized vehicles, which are required in conventional methods, become unnecessary. Thus, the process becomes short and transportation cost and other construction costs are reduced.

(6) Since miniaturized apparatus is used, the test process becomes very fast and construction noise is reduced; thus it is good for the environment. For this reason, it can also be use in residential area and narrow places.

### BRIEF DESCRIPTION OF THE DRAWINGS

FIG. 1 illustrates the principle of this invention;

FIG. 2 illustrates the principle of this invention;

FIG. 3 illustrates the principle of this invention;

FIG. 4 illustrates the present ground test method in order to clarify the concept of this invention;

FIG. 5 illustrates the present ground test method in order to clarify the concept of this invention;

FIG. 6 illustrates the present ground test method in order to clarify the concept of this invention;

FIG. 7 illustrates the present ground test method in order to clarify the concept of this invention;

FIG. 8 illustrates the present ground test method in order to clarify the concept of this invention;

FIG. 9 illustrates the present ground test method in order to clarify the concept of this invention;

FIG. 10 illustrates the present ground test method in order to clarify the concept of this invention;

FIG. 11 illustrates the present ground test method in order to clarify the concept of this invention;

FIG. 12 is a cross section of a first embodiment of this invention;

FIG. 13 is a cross section of the first embodiment of this invention;

FIG. 14 is a cross section of a second embodiment of this invention;

FIG. 15 is a cross section of the second embodiment of this invention;

FIG. 16 illustrates details of shear stress measurement of the second embodiment of this invention;

FIG. 17 illustrates details of shear stress measurement of the second embodiment of this invention;

FIG. 18 illustrates details of shear stress measurement of the second embodiment of this invention;

FIG. 19 is a longitudinal section of a third embodiment of this invention;

FIG. 20 is a cross section of the third embodiment of this invention;

FIG. 21 is a side view of the third embodiment of this invention;

FIG. 22 illustrates details of shear stress measurement of the third embodiment of this invention;

FIG. 23 illustrates details of shear stress measurement of the third embodiment of this invention;

FIG. 24 is a longitudinal section of a fourth embodiment of this invention;

FIG. 25 is a cross section of the fourth embodiment of this invention;

FIG. 26 is a cross section of fifth embodiment of this invention;

FIG. 27 illustrates the total structure of a sixth embodiment of this invention; and

FIG. 28 is a cross section of the apparatus for circulation fluid exudation of the sixth embodiment of this invention.

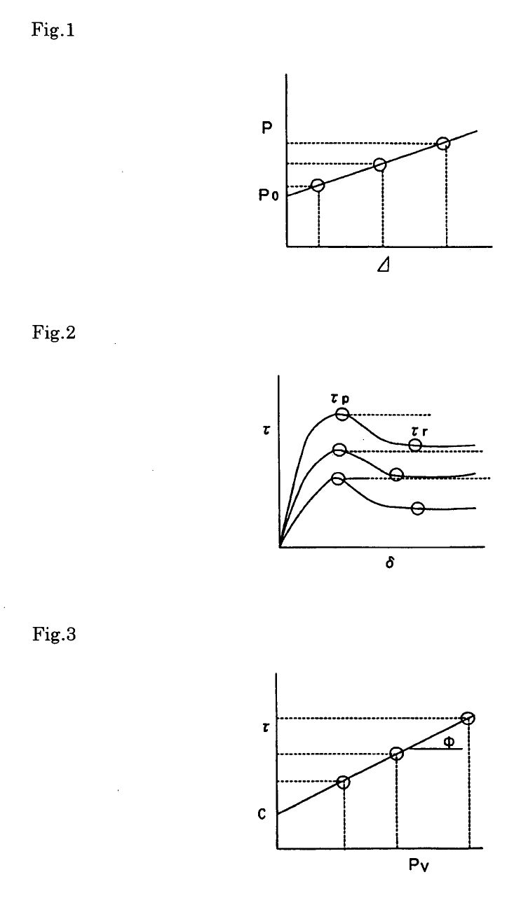

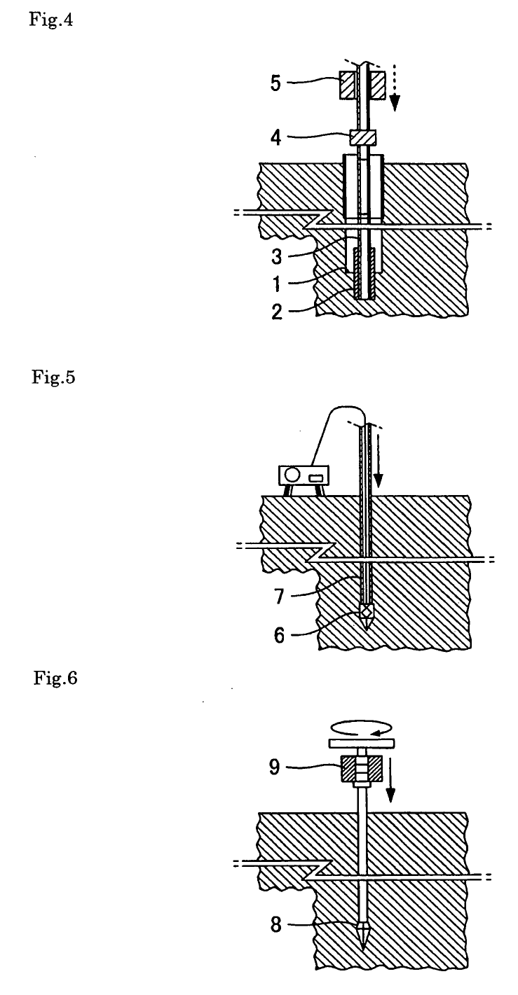

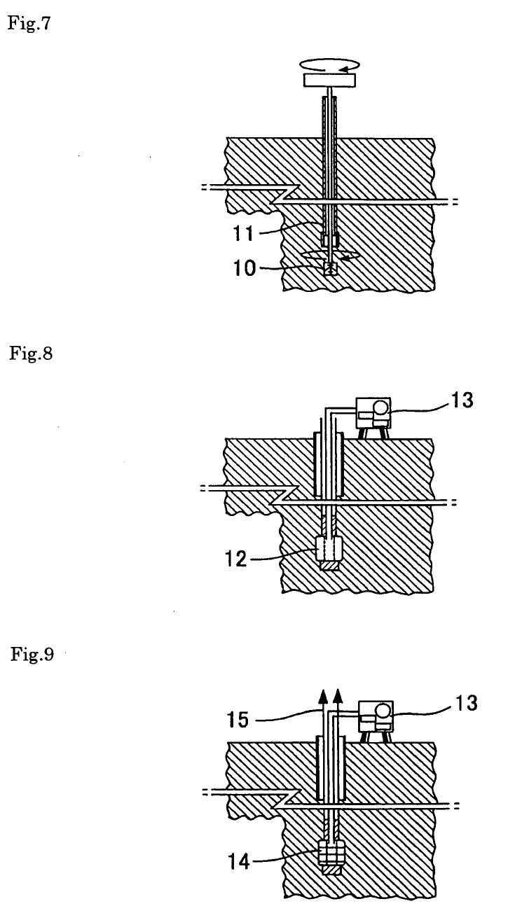

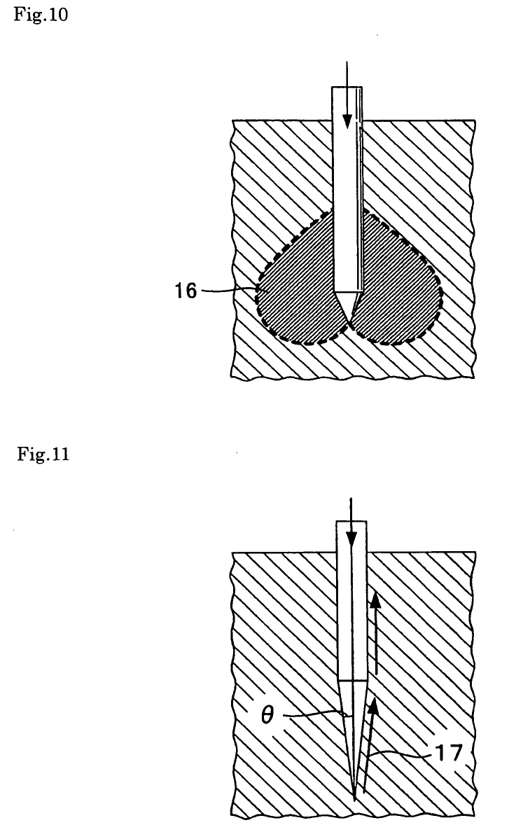

### DESCRIPTION OF SYMBOLS

1: base of hole, 2: pipe-shaped resistor,
3: boring rod, 4: knocking head,
5: hammer, 6: conical resistor,
7: rod, 8: resistor shaped as twisted pyramid,
9: weight, 10: vane,
11: double tube rod, 12: pressurization cell,
13: pressurization gauge using pressurization cell, 14: measurement pipe,
15: drawing force, 16: failure zone,
17: conical resistance of gentle inclination, 18: load transmission pipe,
19: shoe unit, 20: dummy vane,
21: pressurization shear unit, 22: pressurization shear unit,
23: pressurization shear unit, 24: dummy unit,
25: torque transmission key, 26: active rotation unit,
27: load cell, 28: connection pin,
29: passive rotation unit, 30: vane,
31: rod joint, 34: pressurization plate,
35: sliding sheet, 36: load transmission plate,
37: cable hole, 38: connection material,
39: shoe, 40: upper part of dummy vane,
41: single vane, 42: vane for static earth pressure,
43: lower part of dummy vane, 44: seal of elastic material,
45: tension gauge of different units, 46: fixed screw,
47: gauge for measuring P, 48: connection rod,
49: plate for adjusting height, 50: fixed pin,
51: hole for drawing cable, 52: tension gauge,
53: screw hole, 54: cover,
55: load transmission plate rib, 56: slide pin,
57: hammer sensor, 58: rope with hanged hammer,
59: connection rope, 60: cushion material,
61: automatic knocking head,
62: resistor, 63: support for expansion and contraction,
64: rod (case), 65: spring stopper,
66: spring, 67: holed dashboard,
68: piston use for weight, 69: cylinder,
70: lubrication fluid, 71: fluid ejection tunnel,
72: internal tunnel, 73: valve for inverse stopping

### DETAILED DESCRIPTION OF THE INVENTION

This invention is explained in detail below with its best form for execution using the figures.

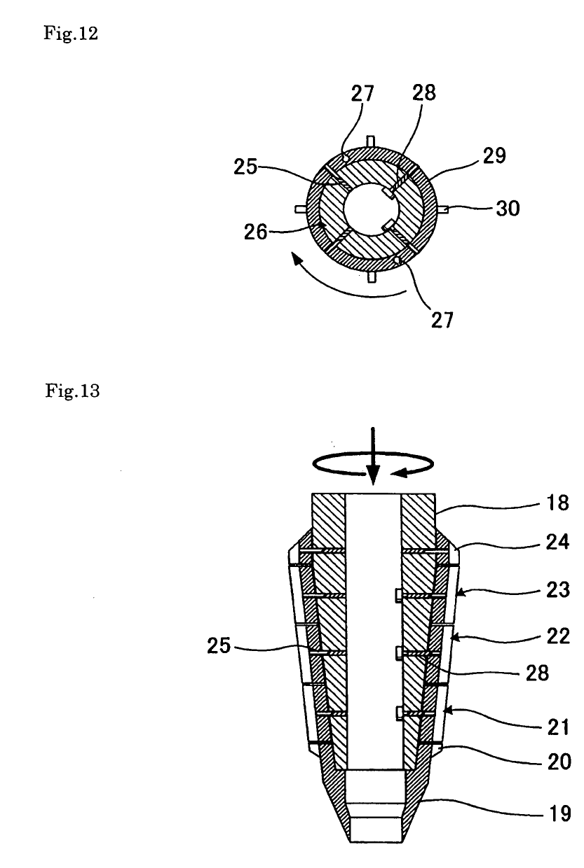

Turning now to FIGS. 12 and 13, an example of vane shear test according to a first embodiment of the invention is illustrated. These figures show an apparatus for pressurization shear test with hollow truncated cone. The load pipe (18) is attached at the tip of rod which penetrates soft ground statically. If penetration is difficult by this method, a weight is use for administering blows. The resistor is hollow truncated cone and the shoe unit (19) is connected to load pipe with taper of θ≦5 degrees so that the ground would not be disturbed. Also, a dummy vane (20) is attached at the upper part (in order to eliminate the resistance of vane at the bottom). The main part of resistor is cone-shaped of θ≦3 degrees. This is divided into three equal parts as pressurization shear units 1, 2 and 3 (21, 22 and 23), each are attached around the vane (30) of lateral width B in a single line. The most upper part is the upper dummy unit (24) attached with dummy vane. Pressurization shear unit is divided into two parts. One is the active rotation unit (26) that is connected with torque transmission key (25) at the load pipe. The other part is the passive rotation unit (29) that is free to rotate and has connection pin (28). Tensile force acts on the resistor when load pipe penetrates. Lateral ground reaction P acts on each unit in circular direction of the same center when the 3 pressurization shear units and dummy unit are dragged underneath. This is measured using 2 load cells (27) as circumferential stress (theoretically both are equal). The normal stress acting on shear plane of vane circumference is calculated using the measured pressure. When the load pipe is rotated, rotational force is transmitted from active rotation unit to passive rotation unit. The resistance of passive rotation unit that is displayed in load cell can be use to compute the shear resistance torque and shear strength. According to this method, E, C and φ in the direction of depth can be calculated by repetition of resistor's penetration and rotation.

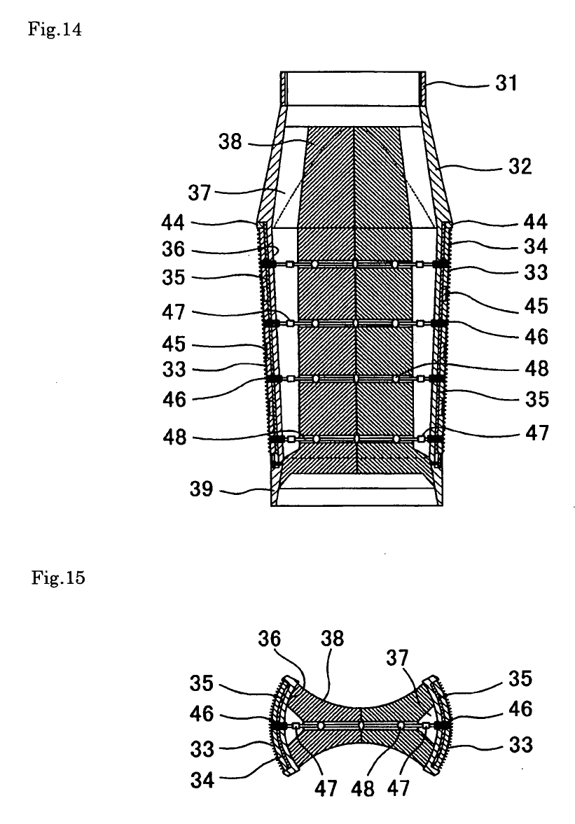

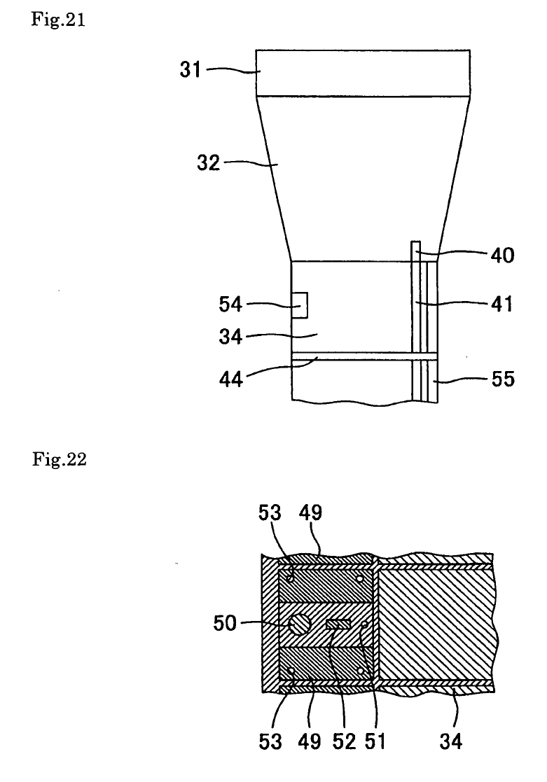

A second embodiment of this invention (fractured cross section of penetration apparatus for pressurization shear test) is explained above and is illustrated in FIG. 14 to 26. Since it uses hollow conical resistor (with a combination of self-boring test or trimming type of pre-boring test) and does not require usual boring process, speed of test is fast and operation is simple. Also, since it does not require boring technique in usual cases, precision of measurement becomes highly stable. The best form for conducting the second embodiment is shown in FIGS. 14 and 15 that is equipped from side to side.

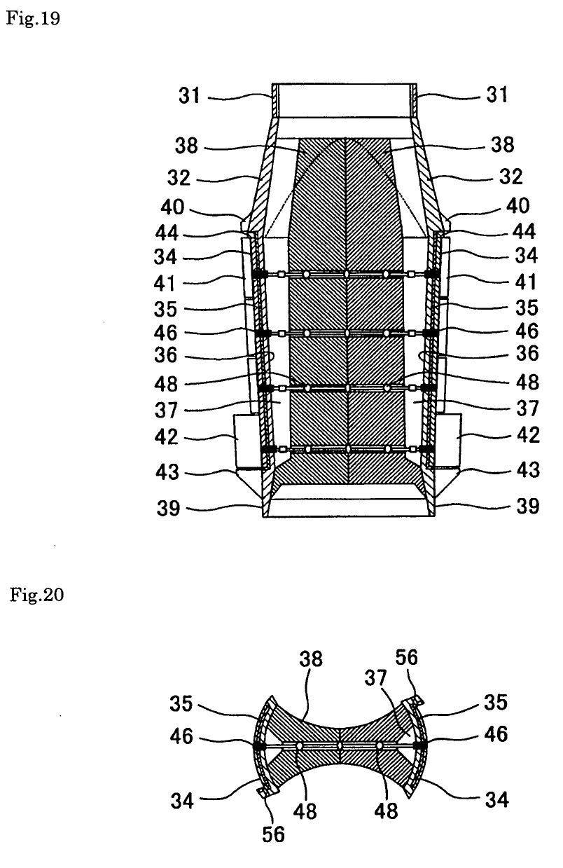

FIGS. 14 to 26 show example regarding the first embodiment of the invention. These explain the resistor part (fractured cross section of penetration apparatus for pressurization rotation shear test). It comprises FIGS. 14, 21, 15, 26, 16 and 22. FIGS. 19, 26, 20, 22 and 23 correspond to the first embodiment.

FIG. 14 is a profile diagram of resistor when cut at the center of shear plane lengthwise. The horizontal plane indicated by the arrow is shown in FIG. 18. As for reference, the H-shaped section is shown in FIG. 26. The penetration rod is connected to the head of resistor rod joint (31). Penetration force is transmitted to two arc members through diverge joint (32) from this pipe. The pair of arc member end becomes narrow by angle of θ=1 to 2 degrees due to joint member (38). The shear plane of arc member is uniform from top to bottom but the radius of curvature of exterior becomes smaller at the bottom. However, the tip of shoe (39) has constant curvature θ=0.

The external portion of pressurization shear member (33) consists of 4 units each having a built-in gauge for measuring lateral ground reaction P. The force P on both ends of the pressurization shear member that pierce through the hole of joint member each acts at fix screw (46). The compressive force generated in coupling rod (48) for anti-buckling and centering is measured using the gauge for P.

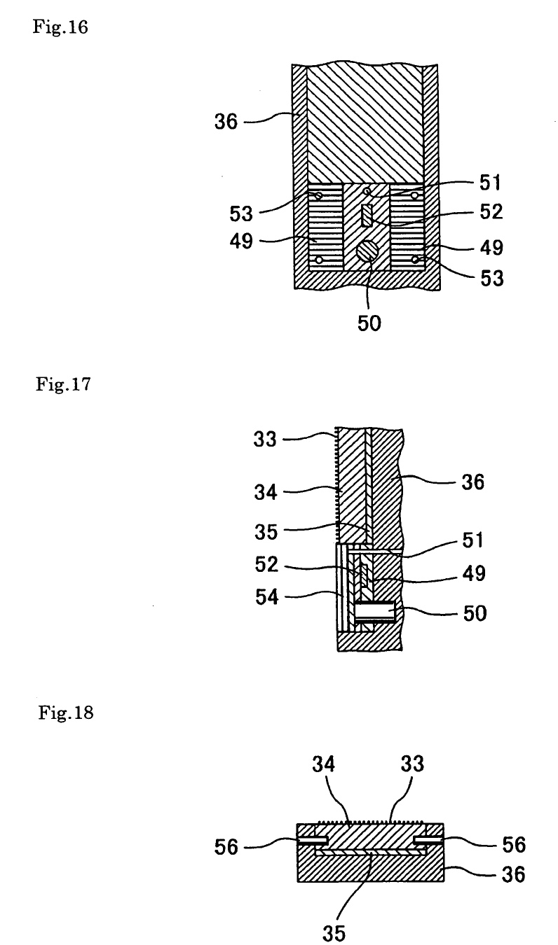

The penetration force of the resistor is transmitted to the shoe and tip of pressurization shear member using two load plates (36) that is connected to joint member as one. Therefore, since the pressurization shear member is dragged by the shoe during penetration, the shear force of ground is determined by measuring the tensile force at the boundaries of pressurization shear member units. Thus, the internal part of unit boundary is grooved to generate stress concentration and shear force is found from tensile force of each unit using strain gauges. Moreover, the end of pressurization shear member is connected to the shoe as illustrated in FIGS. 16 and 17. As shown in the figure, pressurization shear member of T-shape has thin width and flat in both sides in order to measure stress at the center of plate except curvature. Tension gauge (52) is affixed in both sides and height control plate (49) is set over the plate. The fix pin (50) is fixed by the load plate immediately above the shoe. The tension gauge protected by waterproofed cushion and the cover (54) is fixed with 4 tapped holes (53) and flattened around the circumference.

The pressurization shear member is built with a surface average roughness of 0.5 mm. The end, as shown in FIG. 18, is set to have the same thickness with that of pressurization shear member at both sides of load plate. Pressurization shear member is inserted in between and slide pin (56) is set at the side in order to prevent separation of load plate when sliding vertically. Moreover, in order to eliminate compressive force when rising, the upper part is concealed below the diverged joint (not illustrated). Furthermore, thin slide sheet (35) is inserted between the pressurization shear member and load plate and it is sealed by elastic agent (44) in order to protect the connection plane of member from mud.

Cables of various sensors pass through the holes (37) near the boundary of joint member and load plate and rise up to rod joint. Then, it passes through penetration rod (not illustrated), pull up to the surface and connect to measurement apparatus (not illustrated). Moreover, FIG. 26 shows conception diagram for H-shaped member and not for arc member.

FIG. 19 is the vertical section diagram of the resistor cut at the center of the shear plane. The cross section indicated by the arrow is shown in FIG. 20. The penetration rod is connected to rod joint (31) on top of the resistor. Penetration force is transmitted to two arc members through branch join (32) from this pipe. The pair of arc member's tip is narrowed by about θ=1 degree using connection material (38). Although the width of arc member's shear plane is the same from top to bottom, the radius of curvature of exterior plane becomes small at the bottom (the arc is from the center of member). Provided that the curvature at the tip of shoe (39) is constant and θ=0.

The exterior pressurization plate (34) is composed of four units each having a built in instrument for measuring lateral ground reaction P. The fix screw (46) accepts P that acts on pressurization shear material in both sides of the hole which the connection material passes through. The compression force acting on connection rod (48) for anti-buckling is measured using the gauge for P.

The penetration force of resistor is transmitted at the tip of shoe and pressurization shear material from the branch joint mentioned earlier to the two load transmission plates (36) that is composed of connection materials. There are four units of vane (41) attached to pressurization plate. The vane in the bottom unit is the static earth pressure vane (42) which has a wider width B compared to the other units. This is for the purpose of measuring the shear resistance in static earth pressure condition. Also, in order to eliminate the disorder caused by the penetration of shoe and the lateral ground reaction due to the diameter difference of the unit and the shoe where the unit average diameter is slightly larger than the shoe. When the whole length of resistor is penetrated and rotated, shear of ground occurs at the arc due to vane. In order to cancel the shear resistance at the top and bottom of vane, upper dummy vane (40) and lower dummy vane (43) are attached (however, the two resistance acting on the static earth pressure vane upper surface cancel each other in calculation).

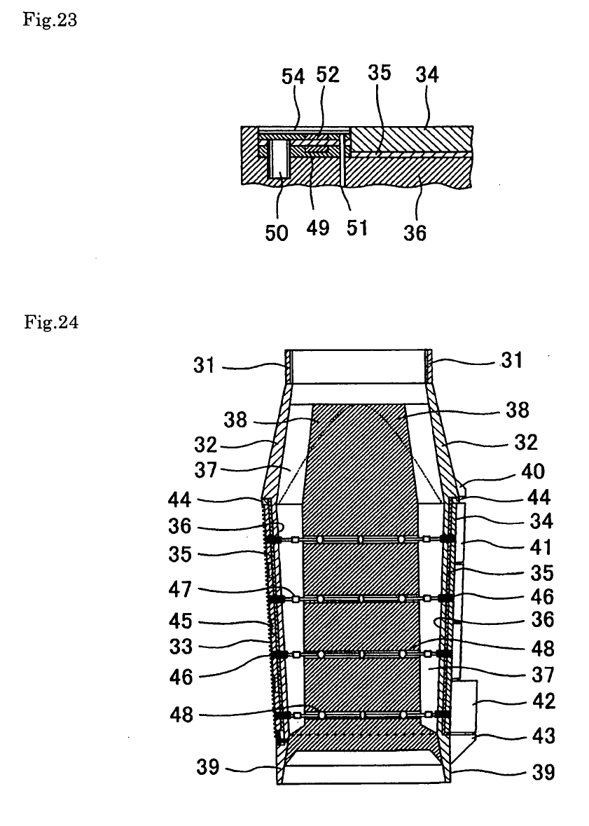

The rotation shear torque is illustrated in FIGS. 22 and 23. The pressurization shear material is mounted to load transmission plate with thin slide sheet (35) inserted in each unit. FIG. 22 shows the side view in which the cover (54) is removed and FIG. 23 is the cross section at its center. Smooth and slippery material is used in pressurization shear surface. Its left side is narrowed in shaped of the letter T as illustrated in the figure. Moreover, in order to measure the pressure at the center of plate, the front and back is shaved to thin plate, tension gauge (52) is attached in both sides, height adjustment plate (49) is inserted at the top, and the right side of load transmission plate is fixed using fix pin (50). The tension gauge is protected by waterproof cushion and the lead line passes the cable drawer hole (51) and is drawn out from the cable hole (37). The cover is fixed in the four screw holes (53) and its periphery is flattened. In the other end right side, the edge of load transmission plate is made to have the same thickness with that of the vane height. The vane is connected to slide pin (56) through the cushion sheet and the pressurization shear plate is connected so that it is free to rotate while in contact with the load transmission plate. Therefore, when the load transmission plate is rotated and ground is sheared by the vane, tension occurs in the pressurization shear material through the fix pin.

The top of pressurization shear highest unit is concealed in the bottom of branch joint in order to prevent compression force during lifting of resistor (not illustrated). Similarly, the bottom of pressurization shear lowest part is concealed on top of shoe upper portion (not illustrated). In addition, the connection side of member at the surface is protected by elastic seal (44) against invasion of trashes.

The cables of different sensors pass through the cable holes (37) near the border of connection material and load transmission plate, raise up to the rod joint, pass through the penetration rod (not illustrated), pulled up to the surface and connected to the measurement device (not illustrated).

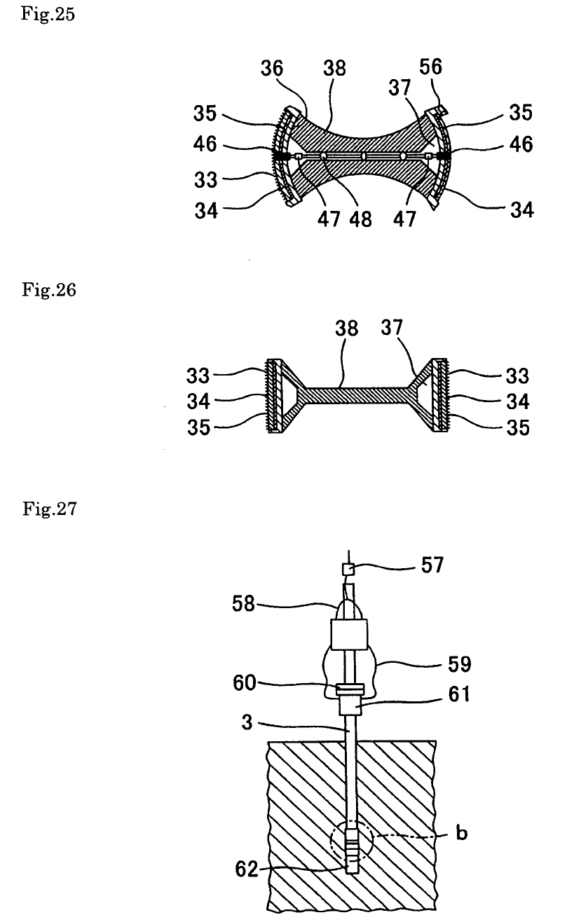

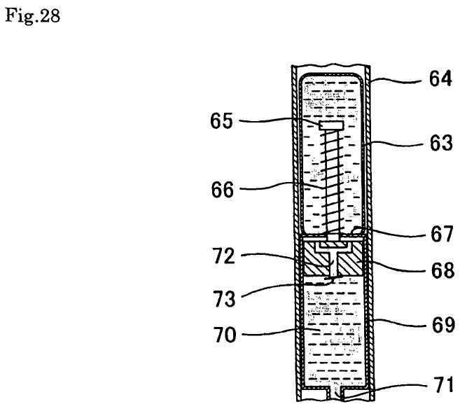

The best form is shown in FIGS. 24 and 25, where FIG. 24 is the vertical section and FIG. 25 is the cross section, in which the first and second embodiments are combined as one. Using this apparatus, penetration shear test and rotation shear test can be applied according to situation in grounds consisting of various stratum constitutions without replacement of resistor. Furthermore, it can be applied to moderately hard ground by combining the use of blow driven penetration and lubricant exudation method of the third embodiment as shown in FIGS. 27 and 28.

In FIG. 27, penetration is performed by administering blows where a resistor (62) is attached at the tip of a rod (3). The hammer (5) is hung (not illustrated) using rope (58) with a sensor. When the hammer is suddenly dropped, it triggers the initial time of fall and starts various measurement devices within few seconds. When the hammer is lifted up using connection rope (59), automatic knocking head (61) also rise up together. If the lifting is stopped maintaining a constant distance from hammer, the knocking head automatically fixed to rod and the blow force of hammer is transmitted to the rod. Cushion material (60) is put over the knocking block in order to extend the transmission time of blow energy by ten times (in order to apply to various type of ground, time is adjusted by the thickness of cushion material). As result, multiple measurement of information from various sensors becomes possible and suggest solution to noise reduction.

FIG. 28 illustrates a mechanism example on how to make penetration easy by decreasing the friction of resistor surface (other than shear plane). Inside the resistor or rod case (64) are the cylinder (69) and support for expansion and contraction (63) which are filled with lubricant fluid (70). The piston (68) that is also use as weight is consist of pipe fixed at the top as support, spring for holding (65), dashboard (67) with holes attached to the cylinder and spring (66) inserted in between. The piston touches the base of dashboard on top of cylinder. The blow force is transmitted through the rod to the dashboard with holes. The piston becomes the downward force as product of its mass and acceleration. The spring is compressed and lubricant fluid is spitted out of the fluid ejection tunnel (71); a valve is installed (not illustrated) to prevent subsurface water from flowing backward to the end). In this case, the fluid inside the support for expansion and contraction at the top of piston passes through the dashboard with holes and flow inside the cylinder. Then, while the piston gradually rises due to spring force, it passes through the tunnel (72) installed inside the piston and flow to the cylinder below the piston from the valve (73). Moreover, easy expansion and contraction of support becomes possible since the internal of rod is connected to the surface and pressure is set below atmospheric pressure (below hydraulic pressure during water flow). Also, dry coating or self-printing materials are applied to the surface in order to improve the reduction of friction on resistor.

Using the above apparatus, C, φ and E are measured by penetration of resistor. Static penetration for relatively soft ground, rapid loading by blow driven penetration for harder ground, and trimming boring method for much harder ground that is unusually difficult to penetrate.

The information of ground is very important in the design of buildings and public work structures. Also, the relationship of ground to its construction, execution and repair works is significant. Moreover, advanced technologies on countermeasures against mudslides and earthquake disaster and protection method against disaster are demanded increasingly. This invention solves the problems of in situ test methods which is an important field in the ground test industry, thus, it will reform the typical methods of this field and might replace these tests for the next generation.

1-3. (canceled)

4. A searching method for acquiring ground information on a strength and deformation of the ground, comprising:
mounting a resistor at a tip of a rod;
piercing the ground in a piercing direction with the resistor, said resistor including a frustum of a circular cone or an arc member containing a deficient sectional shape, in which an angle made between a side face of the resistor having vanes in a same direction as the piercing direction and the piercing direction is 5 degrees or less upward and outward from a leading end of the resistor, thereby to measure a plurality of transverse ground reactions; and
rotating the resistor having the vanes at an achieved depth, thereby to measure a plurality of ground shearing forces.

5. A searching method for acquiring ground information on a strength and deformation of the ground, comprising:
mounting a resistor at a tip of a rod, a part or a whole side of the resistor being considered as a shear plane of the ground and having a shear surface presenting a degree of coarseness sufficient such that the ground in contact to said surface is inhibited against sliding, said resistor being cone-shaped and including a fractured section or an H-shaped section, an angle of which is equal to or less than 5 degrees;
piercing the ground in a piercing direction with the resistor, is made to penetrate through ground while generating lateral ground reaction, wherein a boundary surface of the ground fails to shear; and
determining the ground strength and the deformation by measuring sets of displacements, ground reactions and shear forces.

6. The method according to claim 5, wherein the shear surface has an average roughness that is greater than half of a mean diameter of target soil.

7. A searching method for acquiring ground information on a strength and deformation of the ground, comprising:
mounting a resistor at a tip of a rod;
penetrating the ground with the resistor by administering blows of a hammer to a knocking head, cushion material being mounted between the hammer and the knocking head, such that a transmission of impact energy is delayed, thereby extending loading time up to approximately 10 times;
detecting a starting time of dropping of the hammer; and
measuring ground reaction and shear force a predetermined number of times within said loading time.

8. The method according to claim 7, wherein detecting a starting time includes using a sensor.

9. The method according to claim 7, further comprising:
suspending a piston used as a weight inside a cylinder filled with lubricant and mounted to an inside or upper part of the resistor using elastic material; and
vibrating the weight vertically when said blows are administered, and due to an attendant fluctuation of pressure, causing the lubricant to flow through a tunnel connected to the cylinder and to be exuded to a target side.
